(19) United States
(12) Patent Application Publication
(10) Pub. No.: US 2003/0026188 A1
(43) Pub. Date: Feb. 6, 2003

(54) Thinner structure for electronic devices, and provision of given space in electronic devices

(75) Inventors: Atsuko Sugiura, Tokyo (JP); Naoya Ishii, Tokyo (JP); Toshiaki Uotani, Niigata (JP); Takashi Taga, Niigata (JP); Yutaka Araki, Nagano (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/205,777

(22) Filed: Jul. 26, 2002

(30) Foreign Application Priority Data
Aug. 3, 2001 (JP) 2001-236679

(51) Int. Cl. G11B 33/02

(52) U.S. Cl. 369/75.2

(57) ABSTRACT

An electronic device is arranged to be of a thinner structure and to provide a sufficient space required therein. The electronic device has a drive for driving a recording medium in the upper part thereof and incorporates a tray mechanism or a slot-in mechanism for inserting and removing the recording medium from the upper side of the drive.

### BACKGROUND OF THE INVENTION

1. Field of the Invention

The present invention relates to an electronic device which accommodates therein a drive for a recording medium such as a CD, a DVD, or the like.

2. Description of the Related Art

Heretofore, there have been proposed various arrangements for facilitating loading and unloading of recording mediums in portable electronic devices which accommodate therein a drive for a recording medium such as a CD, a DVD, or the like.

For example, FIG. 1A of the accompanying drawings shows an arrangement in which tray 91 is insertable into and removable from a front panel of an electronic device, and a recording medium with its face up can be loaded on and unloaded from tray 91. FIG. 1B of the accompanying drawings shows another arrangement in which tray 92 is insertable into and removable from a side panel of an electronic device, and a recording medium with its face forward can be loaded on and unloaded from tray 92. FIG. 1C of the accompanying drawings shows still another arrangement in which cover 93 on a front panel of an electronic device is openable and closable, and a recording medium with its face forward can be loaded on and unloaded from an electronic device body with cover 93 being open.

Portable electronic devices are desired to be of a thinner structure for better portability and installation. However, the arrangement shown in FIG. 1A is disadvantageous in that the electronic device cannot be of a thinner structure because the depth of the electronic device needs to be greater than the depth of tray 91.

It has been desired that portable electronic devices improve the quality of reproduced sounds at the time audio information recorded in a recording medium is output. With the arrangement shown in FIG. 1B, however, it is difficult to improve the quality of reproduced sounds as a space which accommodates a speaker therein is limited to a small volume.

Attempts have been made to design portable electronic devices incorporating many functions therein. For example, some recent portable electronic devices have a display unit for the purposes of connecting to the Internet and carrying out various information processing features such as sending and receiving e-mail messages, browsing home pages on the Internet, and manipulating files. In this respect, the arrangement shown in FIG. 1C is problematic because it fails to provide a space for the installation of a display unit.

### SUMMARY OF THE INVENTION

It is therefore an object of the present invention to provide an electronic device which is arranged to provide a space for installing a speaker or a display unit therein, and to be of a thinner structure.

To achieve the above object, there is provided in accordance with the present invention an electronic device having a drive for driving a recording medium in the upper part thereof, so that the recording medium can be inserted and removed from the upper side of the drive. Therefore, the electronic device can provide a sufficient space therein for installing a speaker and a space for installing a display device, and can be of a thinner structure.

If the drive incorporates a tray mechanism for loading the recording medium, then the drive may be thinner than if it incorporates a slot-in mechanism, thus making the electronic device thinner in structure.

If the drive has a tray, then a rotary pinion is disposed in a body of the electronic device and a rack is disposed on the tray in mesh with the pinion. When the tray is pulled out to a position where the recording medium can be loaded thereon in order to load or unload the recording medium, the rack on the tray and the pinion in the body mesh with each other, causing the pinion to produce torque which makes the tray less liable to drop by gravity. Therefore, the tray is prevented from being closed quickly when the recording medium is loaded or unloaded.

If a viscous material applies to a region of the rack which meshes with the pinion when the tray is pulled out to the position where the recording medium can be loaded thereon, then the viscous material serves to increase the torque produced by the pinion with respect to the rack.

The rack and the pinion may mesh with each other only when the tray is pulled out nearly to the position where the recording medium can be loaded thereon. In this case, when the user presses an opening/closing switch to pull up the tray by a predetermined distance from the upper side of the electronic device, the rack and the pinion do not mesh with each other. At this time, since the pinion produces no torque, the possibility that the tray will not be opened is reduced. This arrangement is achieved by positioning the pinion near an insertion slot for the tray and positioning the rack on a downstream portion of the tray in the direction in which the tray is inserted.

The above and other objects, features, and advantages of the present invention will become apparent from the following description with reference to the accompanying drawings which illustrate examples of the present invention.

### BRIEF DESCRIPTION OF THE DRAWINGS

FIG. 1A is a view illustrative of the manner in which a recording medium is loaded into and unloaded from a conventional electronic device;

FIG. 1B is a view illustrative of the manner in which a recording medium is loaded into and unloaded from another conventional electronic device;

FIG. 1C is a view illustrative of the manner in which a recording medium is loaded into and unloaded from still another conventional electronic device;

FIG. 2A is a front elevational view of an electronic device according to the present invention;

FIG. 2B is a rear elevational view of the electronic device according to the present invention;

FIG. 2C is a view of the electronic device shown in FIG. 2A with a control panel being open;

FIG. 3 is an exploded perspective view of a CD drive mechanism for use in an electronic device according to a first embodiment of the present invention;

FIG. 4 is a view showing the electronic device accommodating the CD drive mechanism shown in FIG. 3;

FIG. 5 is an enlarged fragmentary view of a rack and a pinion which mesh with each other, shown in FIGS. 3 and 4;

FIG. 6 is a cross-sectional view of the pinion and associated parts shown in FIGS. 3 through 5;

FIG. 7A is a view illustrative of the manner in which a CD is loaded into and unloaded from the electronic device shown in FIGS. 3 through 6;

FIG. 7B is a view illustrative of the manner in which a CD is loaded into and unloaded from the electronic device shown in FIGS. 3 through 6;

FIG. 7C is a view illustrative of the manner in which a CD is loaded into and unloaded from the electronic device shown in FIGS. 3 through 6;

FIG. 8 is an exploded perspective view of a CD drive mechanism for use in an electronic device according to a second embodiment of the present invention;

FIG. 9 is a view showing the electronic device accommodating the CD drive mechanism shown in FIG. 8;

FIG. 10A is a view illustrative of the manner in which a CD is loaded into and unloaded from the electronic device shown in FIGS. 8 and 9;

FIG. 10B is a view illustrative of the manner in which a CD is loaded into and unloaded from the electronic device shown in FIGS. 8 and 9;

FIG. 10C is a view illustrative of the manner in which a CD is loaded into and unloaded from the electronic device shown in FIGS. 8 and 9;

FIG. 11A is a perspective view of a CD tray, which is locked, of a CD drive mechanism for use in an electronic device according to a third embodiment of the present invention;

FIG. 11B is a perspective view of the CD tray, which is unlocked, of the CD drive mechanism for use in the electronic device according to the third embodiment of the present invention;

FIG. 12A is a view of the CD tray, which is locked, in the electronic device which accommodates the CD drive mechanism shown in FIGS. 11A and 11B; and

FIG. 12B is a view of the CD tray, which is unlocked, in the electronic device which accommodates the CD drive mechanism shown in FIGS. 11A and 11B.

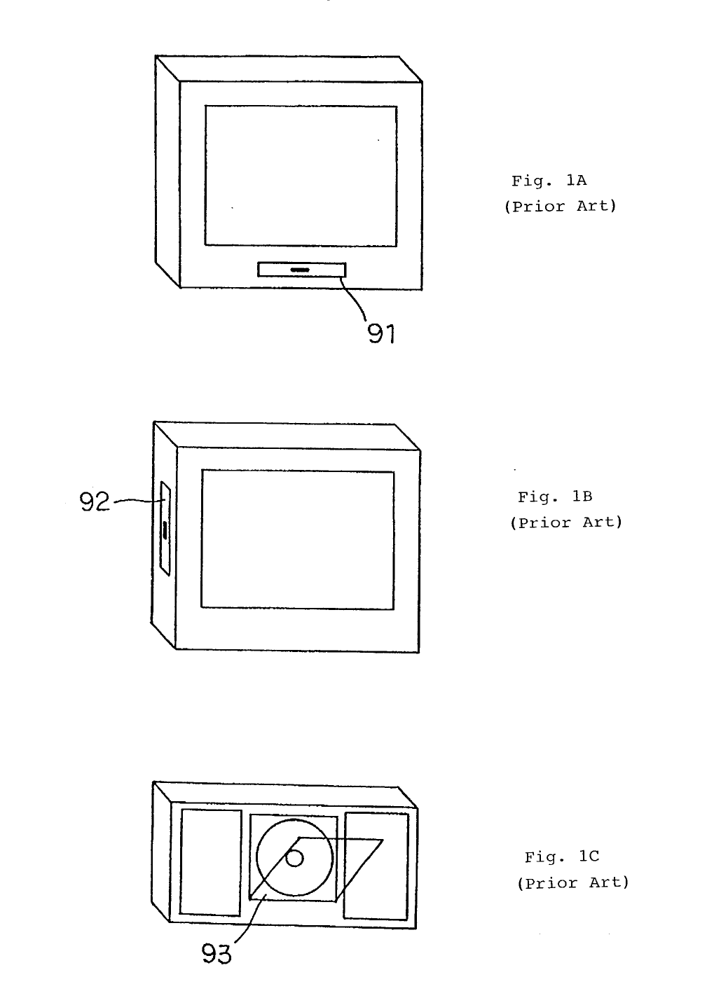

### DESCRIPTION OF THE PREFERRED EMBODIMENTS

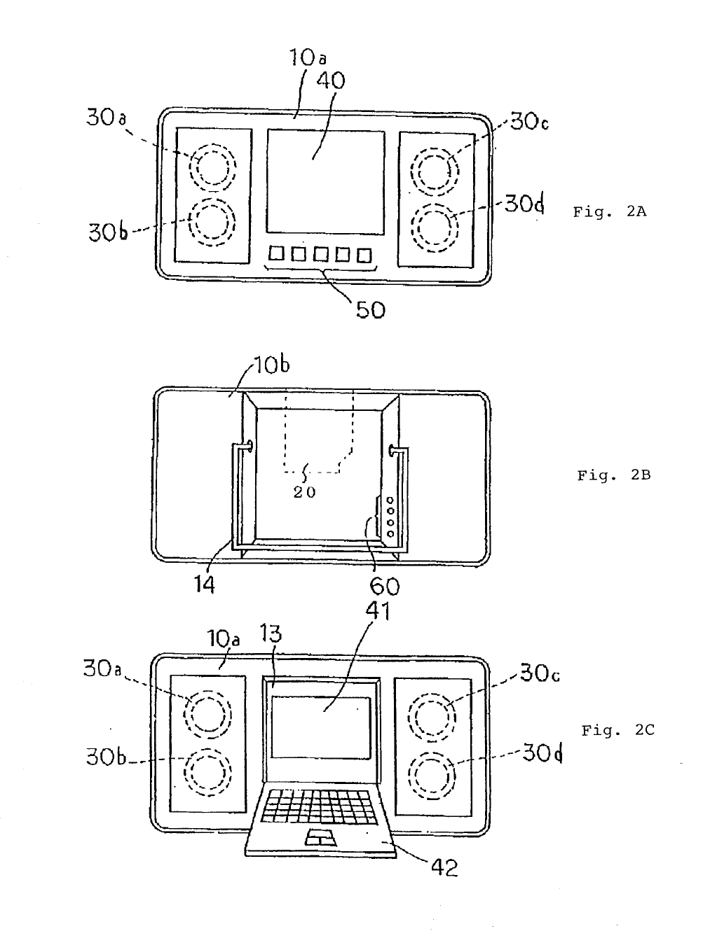

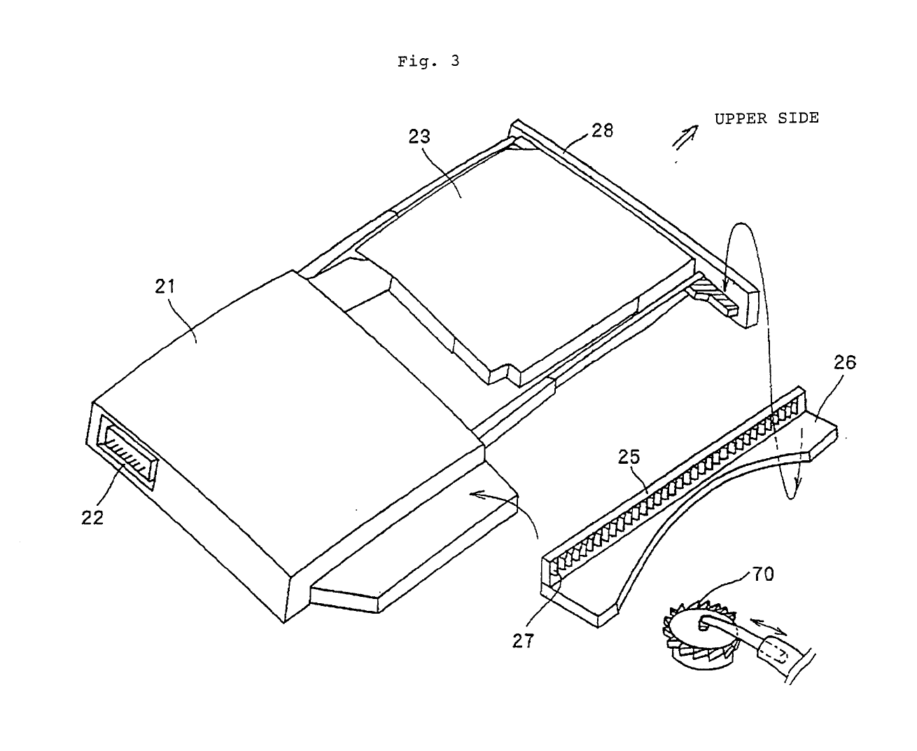

FIGS. 2A through 2C show an electronic device according to the present invention which has switch assembly 50 and control panel 40 on casing 10a that provides a front face of the electronic device.

Switch assembly 50 serves to select functions of the electronic device and also to select and control audio information that is output through speakers 30a through 30d.

Control panel 40 has keyboard 42 and display panel 41.

Keyboard 42 serves to input information for information processing and also to edit audio information that is output through speakers 30a through 30d, as with general personal computers. Information processing that is performed using keyboard 42 includes editing documents, and inputting and controlling information for using the Internet and electronic mail. Keyboard 42 can be stored in storage area 13 which is defined in the front face of the electronic device by casing 10a.

Display panel 41 is mounted on casing 10a so as to face keyboard 42 when it is stored in storage area 13, and serves to display information thereon.

Speakers 30a through 30d, together with an information processor (not shown) for performing various information processing sequences, are placed in a space which is created by casing 10a and another casing 10b that provides a rear face of the electronic device and fits with casing 10a. Speakers 30a through 30d are positioned on both sides of display panel 41 and the information processor. The information processor includes a power supply circuit, a storage circuit such as a memory, etc., a communication circuit for performing communications via a public network, and a control circuit for controlling the display of information on display panel 41 and the outputting of audio information through speakers 30a through 30d.

Casing 10b that provides the rear face of the electronic device supports terminal group 60 and stand 14.

Terminal group 60 serves to send signals to and receive signals from another device (not shown).

Stand 14 can be fixed at any desired angle, and functions as a handle for carrying the electronic device when fixed at a desired angle. When fixed at a desired angle, stand 14 also functions as a stand for allowing the electronic device to stand on a desk or the like.

CD drive mechanism 20 is disposed behind display panel 41 in the upper part of the electronic device. A CD can be inserted into and removed from the upper side of CD drive mechanism 20. CD drive mechanism 20 thus positioned allows a space for installing speakers 30a through 30d therein and a space for accommodating display panel 41 therein, to be provided in the electronic device, and also permits the electronic device to be of a thinner structure.

CD drive mechanism 20 may incorporate a slot-in mechanism or a tray mechanism for loading and unloading a CD. While both the slot-in mechanism and the tray mechanism are applicable to the electronic device according to the present invention, the tray mechanism is preferable to the slot-in mechanism as it allows CD drive mechanism 20 to be of a thinner structure.

Electronic devices according to various embodiments of the present invention, which accommodate a CD drive mechanism including a tray mechanism therein, will be described below.

1st Embodiment:

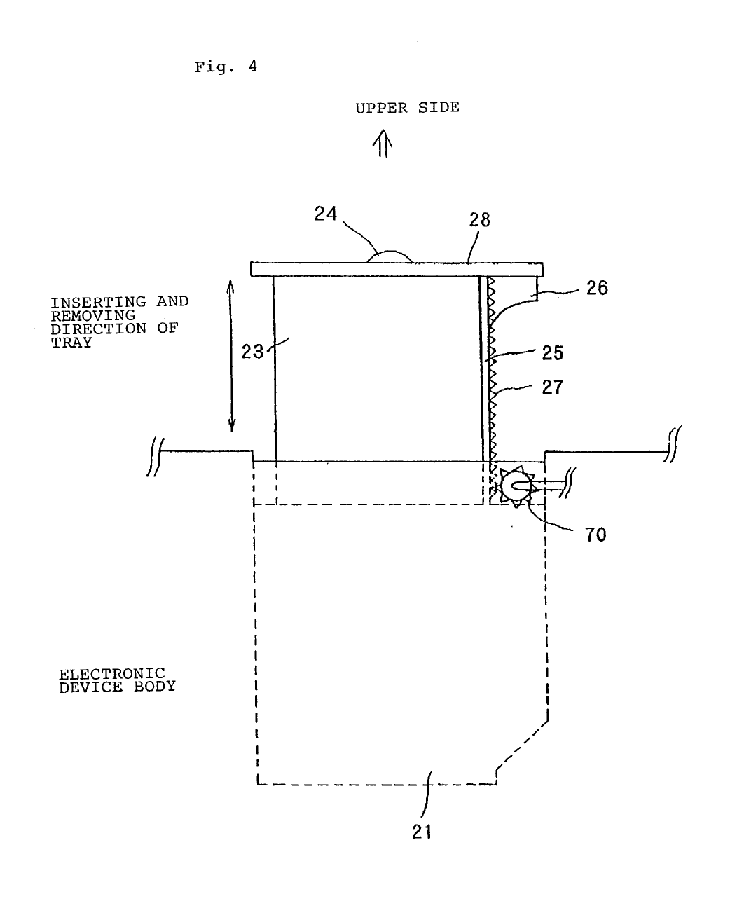

FIGS. 3 and 4 show a CD drive mechanism for use in an electronic device according to a first embodiment of the present invention, which has CD tray 23 that can be inserted and removed from the upper side of the electronic device, and CD drive unit 21 for driving a CD loaded on CD tray 23. CD drive unit 21 is electrically connected to a body of the electronic device by interface 22, and fixed to the body of the electronic device.

Since CD tray 23 can be inserted and removed from the upper side of the electronic device, when the user releases CD tray 23 after it has been pulled out to a position where a CD can be loaded thereon or removed therefrom, CD tray 23 tends to be closed quickly by gravity.

According to the present embodiment, the CD drive mechanism is arranged to prevent CD tray 23 from being closed quickly by gravity when a CD is to be loaded on or unloaded from CD tray 23, as described below.

Guide rail 26 for guiding CD tray 23 is bonded to CD tray 23 of the CD drive mechanism. Guide rail 26 has bar 25 extending in the direction in which CD tray 23 is inserted, the bar 25 having a rack 27 thereon.

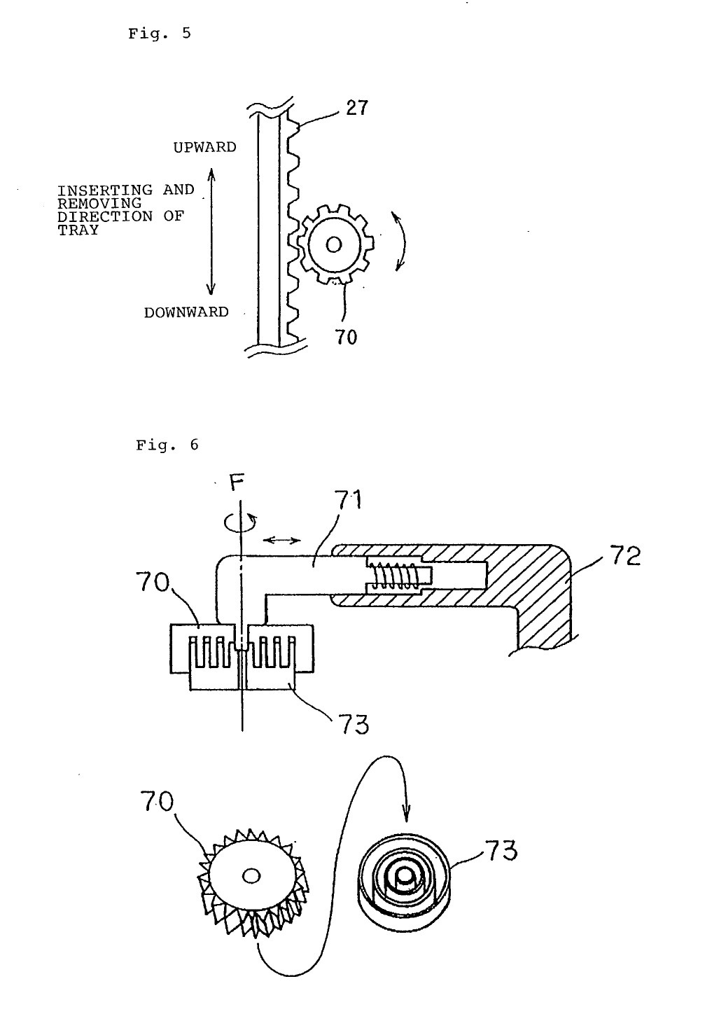

A rotary pinion 70 is disposed in the body of the electronic device near the area where CD tray 23 can be drawn out, and held in mesh with rack 27. FIG. 5 shows rack 27 and pinion 70 which are held in mesh with each other.

When CD tray 23 is pulled out to a position where a CD can be loaded thereon, since rack 27 and pinion 70 are held in mesh with each other, pinion 70 produces torque, which makes CD tray 23 less liable to drop downwards by gravity. Thus, CD tray 23 is prevented from being closed quickly.

When CD tray 23 is pulled out nearly to a position where a CD can be loaded thereon, grease applied as a viscous material to a region of rack 27 which meshes with pinion 70 serves to increase the torque produced by pinion 70 with respect to rack 27, making CD tray 23 much less liable to drop downwards by gravity.

Bezel 28 supports thereon opening/closing switch 24 for opening and closing CD tray 23. When opening/closing switch 24 is pressed while CD tray 23 is being closed, CD tray 23 is pulled upwards by a predetermined distance. A mechanism associated with opening/closing switch 24 is of existing known nature, and will not be described in detail.

As shown in FIG. 6, pinion 70 is engaged with installation member 73 and mounted on arm 71 so as to be rotatable about a pivot F. Arm 71 is mounted on arm 72 fixed to the body of the electronic device for movement in the directions indicated by the arrow.

Pinion 70 has grooves (not shown) defined in a rear surface thereof for engaging grooves in installation member 73. The engaging grooves are coated with grease as a viscous material. The applied grease provides an increased area of contact between pinion 70 and installation member 73, further increasing the torque produced by pinion 70.

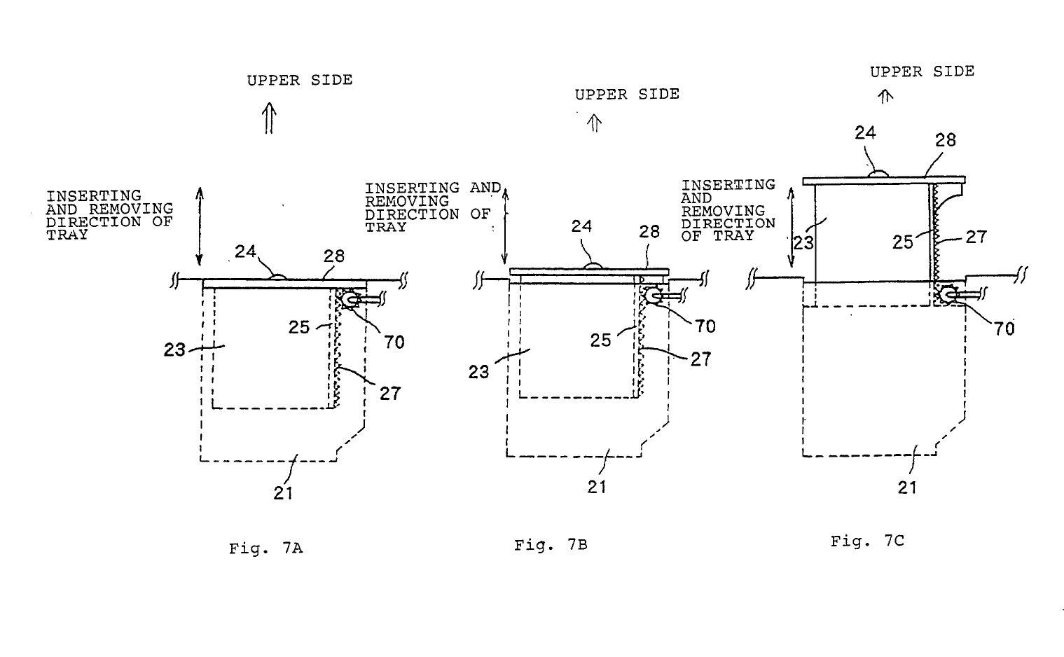

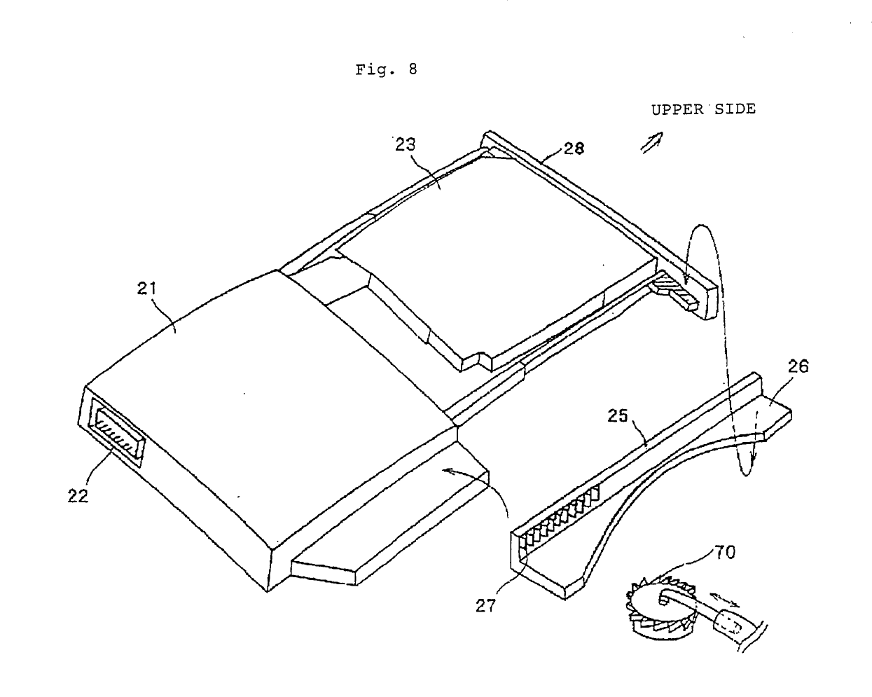

A process of loading a CD into and unloading a CD from the electronic device shown in FIGS. 3 through 6 will be described below with reference to FIGS. 7A through 7C.

When opening/closing switch 24 is pressed while CD tray 23 is being closed (FIG. 7A), CD tray 23 is pulled upwards by a predetermined distance (FIG. 7B).

The user then pulls up CD tray 23 to a position where a CD can be loaded thereon (FIG. 7C), and loads a CD on or unloads a CD from CD tray 23.

At this time, since rack 27 and pinion 70 mesh with each other, pinion 70 produces torque. Since the torque produced by pinion 70 makes CD tray 23 less liable to drop downwards by gravity, CD tray 23 is prevented from being closed quickly. As the grease applied to rack 27 further increases the torque produced by pinion 70, CD tray 23 is made much less liable to drop downwards by gravity.

Thereafter, the user pushes CD tray 23 downwards, returning CD tray 23 to a closed state.

In the present embodiment, rack 27 faces sideways of the CD drive mechanism. However, rack 27 may face in any direction insofar as the object of the present invention can be achieved. For example, rack 27 may face rearwardly of the CD drive mechanism.

In the present embodiment, rack 27 is disposed on bar 25 extending in the direction in which CD tray 23 is inserted. However, rack 27 may be formed directly on guide rail 26.

In the present embodiment, pinion 70 is disposed in the body of the electronic device. However, pinion 70 may be disposed within CD drive unit 21.

2nd Embodiment:

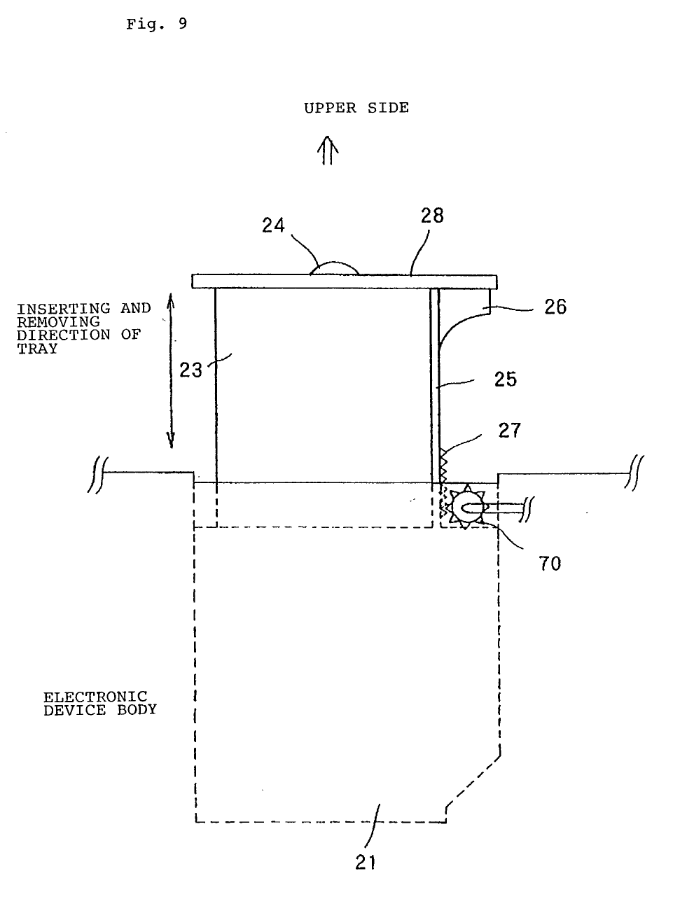

FIGS. 8 and 9 show a CD drive mechanism for use in an electronic device according to a second embodiment of the present invention, the CD drive mechanism having rack 27 which is disposed only on a downstream portion of bar 25 in the direction in which CD tray 23 is inserted.

In the first embodiment, rack 27 is disposed on a substantially entire region of bar 25 in the direction in which CD tray 23 is inserted. Therefore, when opening/closing switch 24 is pressed while CD tray 23 is being closed, CD tray 23 may not possibly be opened due to torque produced by pinion 70 by meshing engagement between rack 27 and pinion 70.

In order to prevent CD tray 23 from being closed quickly by gravity for loading or unloading a CD, rack 27 and pinion 70 may mesh with each other at least when CD tray 23 is pulled out nearly to a position where a CD can be loaded thereon.

According to the present embodiment, rack 27 is disposed only on a downstream portion of bar 25 in the direction in which CD tray 23 is inserted, so that rack 27 and pinion 70 mesh with each other only when CD tray 23 is pulled out nearly to a position where a CD can be loaded thereon.

When the user presses opening/closing switch 24 to pull up CD tray 23 by a predetermined distance, rack 27 and pinion 70 do not mesh with each other. At this time, since pinion 70 produces no torque, the possibility that CD tray 23 will not be opened is reduced.

When CD tray 23 is pulled out to a position where a CD can be loaded thereon, because rack 27 and pinion 70 mesh with each other, CD tray 23 remains prevented from being closed quickly by gravity.

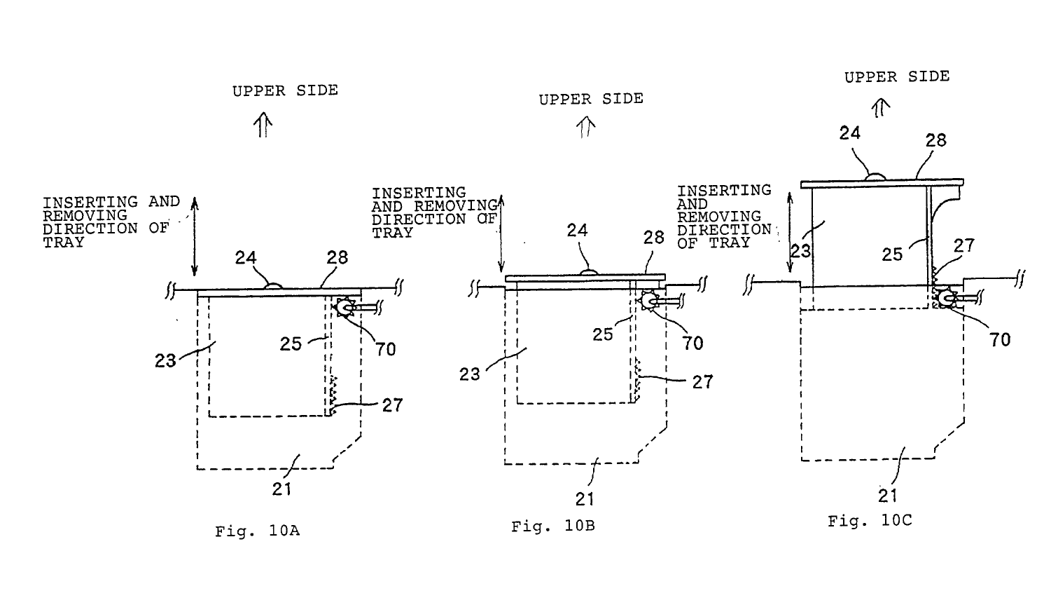

A process of loading a CD into and unloading a CD from the electronic device shown in FIGS. 8 and 9 will be described below with reference to FIGS. 10A through 10C.

When opening/closing switch 24 is pressed while CD tray 23 is being closed (FIG. 10A), CD tray 23 is pulled upwards by a predetermined distance (FIG. 10B).

At this time, since rack 27 and pinion 70 do not mesh with each other, pinion 70 is in a free state, and does not produce any torque. Therefore, when opening/closing switch 24 is pressed, the possibility that CD tray 23 will not be opened due to a torque of pinion 70 is reduced.

The user then pulls up CD tray 23 to a position where a CD can be loaded thereon (FIG. 10C), and loads a CD on or unloads a CD from CD tray 23.

At this time, since rack 27 and pinion 70 mesh with each other, pinion 70 produces torque. Since the torque produced by pinion 70 makes CD tray 23 less liable to drop downwards by gravity, CD tray 23 is prevented from being closed quickly. As the grease applied to rack 27 further increases the torque produced by pinion 70, CD tray 23 is made much less liable to drop downwards by gravity.

Thereafter, the user pushes CD tray 23 downwards, returning CD tray 23 to a closed state.

In the present embodiment, rack 27 faces sideways of the CD drive mechanism. However, rack 27 may face in any direction insofar as the object of the present invention can be achieved. For example, rack 27 may face rearwardly of the CD drive mechanism.

In the present embodiment, rack 27 is disposed on bar 25 extending in the direction in which CD tray 23 is inserted. However, rack 27 may be formed directly on guide rail 26.

In the present embodiment, pinion 70 is disposed in the body of the electronic device. However, pinion 70 may be disposed within CD drive unit 21.

3rd Embodiment:

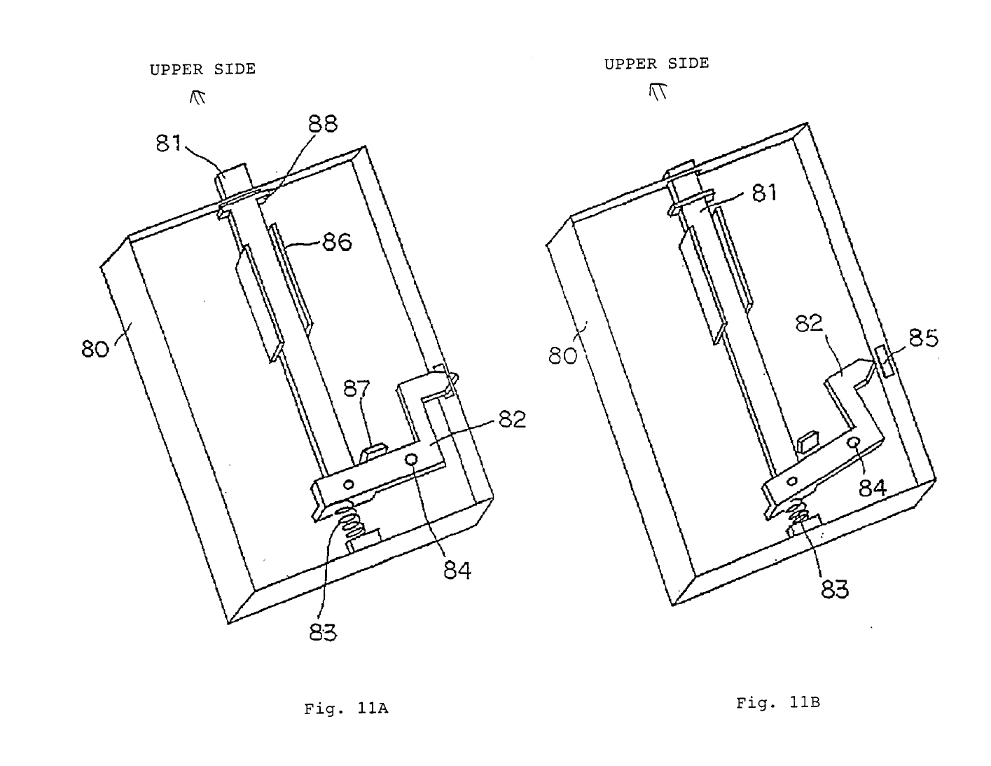

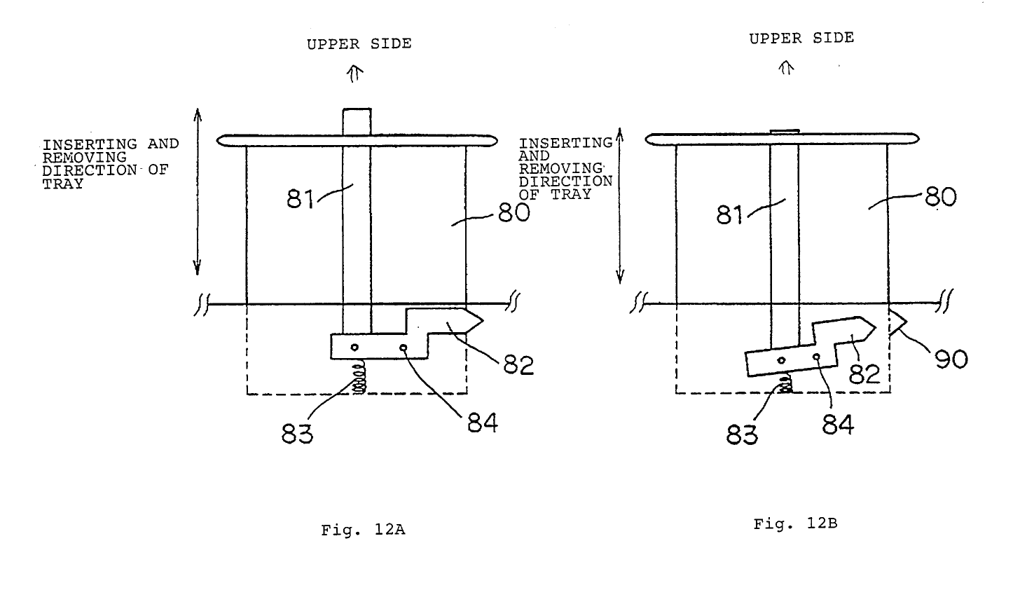

FIGS. 11A, 11B, 12A, and 12B show a CD drive mechanism for use in an electronic device according to a third embodiment of the present invention, the CD drive mechanism having a locking mechanism for fixing CD tray 80 in position when CD tray 80 is pulled out to a position where a CD can be loaded thereon.

The locking mechanism includes link member 81 as a first member, link member 82 as a second member, spring 83 as a pressing member, and guide members 86, 87, all mounted in CD tray 80.

Link member 81 is constructed to have an end projecting from the pull-out end of CD tray 80 and an opposite end disposed in CD tray 80, and is movable in the direction in which CD tray 80 is inserted and removed. Link member 81 has guide member 88 for preventing the end of link member 81 from projecting from the pull-out end of CD tray 80 beyond a certain distance.

Link member 82 is constructed to have an end coupled to the opposite end of link member 81 which is disposed in CD tray 80 and an opposite end that can project through a hole 85 defined in CD tray 80, in which link member 82 is rotatably supported by projection 84 formed on CD tray 80, and the state of projection of link member 82 through hole 85 is determined depending on the rotational movement thereof.

Spring 83 presses link member 81 to cause the end of link member 81 to project from the pull-out end of CD tray 80.

Guide members 86, 87 guide link members 81, 82 respectively in the directions in which they move.

The locking mechanism also includes a recess 90 in the body of the electronic device, for being engaged with the opposite end of link member 82 which projects from hole 85.

When CD tray 80 is to be pulled out, the joint between link members 81, 82 is moved in the direction to pull out CD tray 80, and the opposite end of link member 82 moves to project from hole 85. When CD tray 80 is pulled out to a position where a CD can be loaded thereon, the opposite end of link member 82 projects from hole 85 and engages in recess 90, thus locking CD tray 80.

When CD tray 80 is to be unlocked, link member 81 is pressed downwards to move the joint between link members 81, 82 in the direction in which CD tray 80 is inserted, and the opposite end of link member 82 moves away from recess 90. The opposite end of link member 82 now disengages from recess 90.

In the present embodiment, each of link members 81, 82 comprises a single member. However, each of link members 81, 82 may comprise a plurality of members.

In the above embodiments, a drive for driving a recording medium has been described as a CD drive mechanism. However, the present invention is also applicable to another drive such as a DVD drive mechanism or the like.

While preferred embodiments of the present invention have been described using specific terms, such description is for illustrative purposes only, and it is to be understood that changes and variations may be made without departing from the spirit or scope of the following claims.

What is claimed is:

1. An electronic device comprising:
a drive disposed in the upper part of the electronic device for driving a recording medium which is insertable into and removable from the upper side of said drive; and
a body for processing items of information including information recorded in said recording medium.

2. An electronic device according to claim 1, wherein said drive comprises:
a tray insertable into and removable from the upper side of said drive; and
a drive unit for driving said recording medium loaded on said tray.

3. An electronic device according to claim 1, wherein said drive comprises:
means for loading said recording medium by means of a slot-in mechanism.

4. An electronic device according to claim 2, wherein said body has a rotary pinion, and said tray has a rack meshing with said pinion.

5. An electronic device according to claim 4, wherein said rack meshes with said pinion only when said tray is pulled out to a position where said recording medium can be loaded thereon.

6. An electronic device according to claim 5, wherein said pinion is disposed near the area where said tray be drawn out, and said rack is disposed only on a downstream portion of said tray in the direction in which said tray is inserted.

7. An electronic device according to claim 4, wherein said tray has a guide rail for guiding said tray, and said rack is disposed on said guide rail.

8. An electronic device according to claim 4, wherein said tray has a guide rail for guiding said tray, said guide rail having a bar extending in the direction in which said tray is inserted, and said rack is disposed on said bar.

9. An electronic device according to claim 4, wherein a viscous material is applied to a portion of said rack which meshes with said pinion when said tray is pulled out to a position where said recording medium can be loaded thereon.

10. An electronic device according to claim 9, wherein said viscous material comprises grease.

11. An electronic device according to claim 2, wherein said drive unit has a rotary pinion, and said tray has a rack meshing with said pinion.

12. An electronic device according to claim 11, wherein said rack meshes with said pinion only when said tray is pulled out to a position where said recording medium can be loaded thereon.

13. An electronic device according to claim 12, wherein said pinion is disposed near the area where said tray be drawn out, and said rack is disposed only on a downstream portion of said tray in the direction in which said tray is inserted.

14. An electronic device according to claim 11, wherein said tray has a guide rail for guiding said tray, and said rack is disposed on said guide rail.

15. An electronic device according to claim 11, wherein said tray has a guide rail for guiding said tray, said guide rail having a bar extending in the direction in which said tray is inserted, and said rack is disposed on said bar.

16. An electronic device according to claim 11, wherein a viscous material is applied to a portion of said rack which meshes with said pinion when said tray is pulled out to a position where said recording medium can be loaded thereon.

17. An electronic device according to claim 16, wherein said viscous material comprises grease.

18. An electronic device according to claim 2, further comprising:
a pulling mechanism for pulling out said tray by a predetermined distance as it is closed from the upper side of said drive; and
an opening/closing switch for operating said pulling mechanism.

19. An electronic device according to claim 2, further comprising:
a locking mechanism for fixing said tray in position when said tray is pulled out to a position where said recording medium can be loaded thereon.

20. An electronic device according to claim 19, wherein said locking mechanism comprises:
a first member having an end projecting from the pull-out end of said tray and the opposite end disposed in said tray, said first member being movable in the direction in which said tray is inserted and removed;
a second member having an end coupled to the opposite end of said first member which is disposed in said tray and the opposite end of said second member that can project out of said tray through a hole defined in said tray, said second member being rotatably supported by a projection formed on said tray, the state of projection of said second member through said hole being determined depending on the rotational movement of said second member; and
a pressing member for pressing said first member to cause the end of said first member to project from the pull-out end of said tray; wherein said locking mechanism has a recess defined in said body, for being engaged with the opposite end of said second member which projects from said hole.

21. An electronic device according to claim 20, wherein said first member comprises a plurality of members.

22. An electronic device according to claim 20, wherein said second member comprises a plurality of members.

23. An electronic device according to claim 19, wherein said locking mechanism comprises:
a first member having an end projecting from the pull-out end of said tray and the opposite end disposed in said tray, said first member being movable in the direction in which said tray is inserted and removed;
a second member having an end coupled to the opposite end of said first member which is disposed in said tray and the opposite end of said second member that can project out of said tray through a hole defined in said tray, said second member being rotatably supported by a projection formed on said tray, the state of projection of said second member through said hole being determined depending on the rotational movement of said second member; and
a pressing member for pressing said first member to cause the end of said first member to project from the pull-out end of said tray; wherein said locking mechanism has a recess defined in said drive unit, for being engaged with the opposite end of said second member which projects from said hole.

24. An electronic device according to claim 23, wherein said first member comprises a plurality of members.

25. An electronic device according to claim 23, wherein said second member comprises a plurality of members.

26. An electronic device according to claim 1, wherein said body comprises:
an information processor for processing items of information including information recorded in said recording medium; and
a speaker for outputting audio information processed by said information processor.

27. An electronic device according to claim 1, wherein said body comprises:
a display unit for displaying information processed by said information processor.

28. An electronic device according to claim 27, wherein said body comprises:
a keyboard for inputting information to be processed by said information processor from the outside of the electronic device.

29. An electronic device according to claim 28, wherein said body comprises:
a casing providing a front face of the electronic device and having a storage area for storing said keyboard therein;
said display unit comprising a display panel so disposed as to face said keyboard when the keyboard is stored in said storage area.

30. An electronic device according to claim 1, wherein said electronic device is portable.
